(19) United States
(12) Patent Application Publication
(10) Pub. No.: US 2025/0146816 A1
(43) Pub. Date: May 8, 2025

(54) EFFECT DETERMINATION SYSTEM, EFFECT DETERMINATION METHOD, AND RECORDING MEDIUM

(71) Applicant: NEC Corporation, Minato-ku, Tokyo (JP)

(72) Inventors: Nana Jumonji, Tokyo (JP); Takakazu Ishii, Tokyo (JP); Shouhei Ohno, Tokyo (JP); Hiromichi Hirata, Tokyo (JP); Toshimichi Yokote, Tokyo (JP); Yosuke Kimura, Tokyo (JP); Chisato Sugawara, Tokyo (JP); Yusuke Mizukoshi, Tokyo (JP)

(73) Assignee: NEC Corporation, Minato-ku, Tokyo (JP)

(21) Appl. No.: 18/832,985

(22) PCT Filed: Feb. 28, 2022
(86) PCT No.: PCT/JP2022/008353

§ 371 Date: Jul. 25, 2024

(51) Int. Cl. G01C 11/06; G01S 13/90

(52) U.S. Cl. CPC G01C 11/06; G01S 13/90

(57) ABSTRACT

An effect determination system according to the present invention includes: a memory configured to store instructions; and one or more processors configured to execute the instructions to: acquire a predicted displacement of a structure after an event, the predicted displacement being a displacement of the structure on a ground surface and having been predicted based on a pre-event displacement acquired before the event related to a ground of the structure; acquire a post-event displacement of the structure based on an observation result of the ground surface observed after the event; and determine an effect of the event on the structure based on the predicted displacement and the post-event displacement.

### TECHNICAL FIELD

The present invention relates to determination of an effect of an event on a structure.

### BACKGROUND ART

PTL 1 discloses a ground surface displacement observation device that analyzes measurement of a synthetic aperture radar before, during, and after tunnel construction to calculate a displacement of a ground surface and outputs the displacement of the ground surface. PTL 2 discloses a road shoulder collapse risk monitoring device that measures a shape of a road shoulder and a wheel position of a vehicle, calculates the strength of the road shoulder and a wheel load at the measured wheel position, calculates a collapse risk of the road shoulder at the wheel position based on the calculated strength of the road shoulder and wheel load, and notifies of the calculated collapse risk.

### CITATION LIST

### Patent Literature

PTL 1: JP 2019-132707 A
PTL 2: JP 2011 018132 A

### SUMMARY OF INVENTION

### Technical Problem

Even in a case where there is no event such as construction, a displacement, such as sinking or upheaval, occurs in the ground. A structure, such as a road, deteriorates over time. PTL 1 and PTL 2 do not disclose a technique that determines the effect of an event, such as construction, on a structure.

An object of the present invention is to provide an effect determination system and the like that more appropriately determine an effect of an event on a structure.

### Solution to Problem

According to an aspect of the present invention, there is provided an effect determination system including: a predicted displacement acquisition means for acquiring a predicted displacement of a structure after an event, the predicted displacement being a displacement of the structure on a ground surface and having been predicted based on a pre-event displacement acquired before the event related to a ground of the structure, a displacement acquisition means for acquiring a post-event displacement of the structure based on an observation result of the ground surface observed after the event, and an effect determination means for determining an effect of the event on the structure based on the predicted displacement and the post-event displacement.

According to another aspect of the present invention, there is provided an effect determination method including: acquiring a predicted displacement of a structure after an event, the predicted displacement being a displacement of the structure on a ground surface and having been predicted based on a pre-event displacement acquired before the event related to a ground of the structure, acquiring a post-event displacement of the structure based on an observation result of the ground surface observed after the event, and determining an effect of the event on the structure based on the predicted displacement and the post-event displacement.

According to still another aspect of the present invention, there is provided a recording medium having recorded thereon a program causing a computer to execute: a process of acquiring a predicted displacement of a structure after an event, the predicted displacement being a displacement of the structure on a ground surface and having been predicted based on a pre-event displacement acquired before the event related to a ground of the structure, a process of acquiring a post-event displacement of the structure based on an observation result of the ground surface observed after the event, and a process of determining an effect of the event on the structure based on the predicted displacement and the post-event displacement.

### Advantageous Effects of Invention

According to the present invention, it is possible to more appropriately determine the effect of an event on a structure.

### BRIEF DESCRIPTION OF DRAWINGS

FIG. 1 is a block diagram illustrating an example of a configuration of an effect determination system according to a first example embodiment.

FIG. 2 is a flowchart illustrating an example of an operation of the effect determination system according to the first example embodiment.

FIG. 3 is a block diagram illustrating an example of a configuration of an effect determination system according to a second example embodiment.

FIG. 4 is a diagram illustrating an example of a range determined to be affected by an event.

FIG. 5 is a flowchart illustrating an example of an operation of the effect determination system according to the second example embodiment.

FIG. 6 is a block diagram illustrating an example of a configuration of an effect determination system according to a third example embodiment.

FIG. 7 is a flowchart illustrating an example of an operation of the effect determination system according to the third example embodiment.

FIG. 8 is a diagram illustrating an example of display including sensor information and a surface layer state.

FIG. 9 is a block diagram illustrating an example of a hardware configuration of a computer device constituting the effect determination system.

FIG. 10 is a conceptual diagram illustrating the entire system.

### EXAMPLE EMBODIMENT

Next, example embodiments of the present invention will be described with reference to the drawings. However, each example embodiment of the present invention is not limited to the description of each drawing. Each example embodiment can be appropriately combined.

### First Example Embodiment

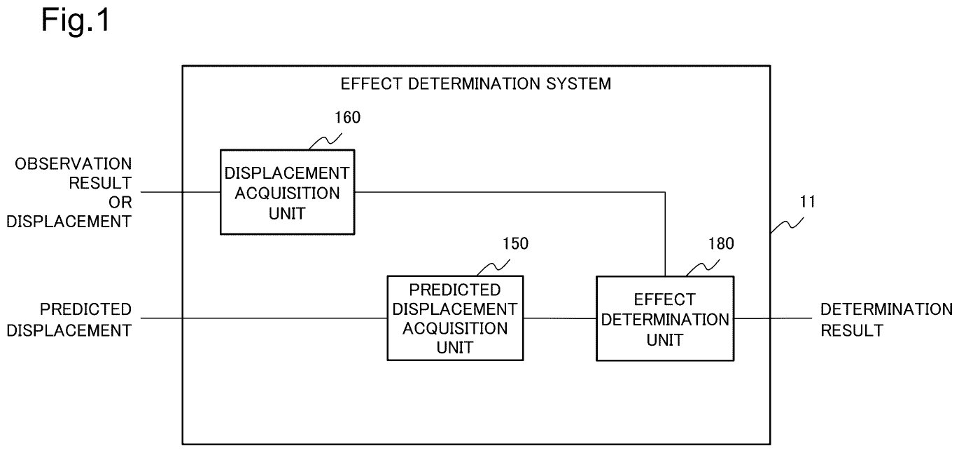

A first example embodiment of the present invention will be described with reference to the drawings. FIG. 1 is a block diagram illustrating an example of a configuration of an effect determination system 11 according to the first example embodiment. The effect determination system 11 includes a predicted displacement acquisition unit 150, a displacement acquisition unit 160, and an effect determination unit 180.

The predicted displacement acquisition unit 150 acquires a displacement predicted in a structure on a ground surface. Hereinafter, the displacement predicted is referred to as a “predicted displacement”. The structure is, for example, a road, a bridge, a slope frame, an embankment, a pier, a revetment, or a runway. The structure may include a plurality of structures such as roads and bridges. However, the structure is not limited thereto. An event related to the ground of the structure is an event that can affect the ground of the structure. For example, the event is underground construction of the structure such as an underground tunnel, an underground mall, an underground parking lot, a common trench, or an underground control pond. However, the event is not limited to the underground construction and may be, for example, construction around the structure that affects the ground of the structure, such as construction of a large building. Alternatively, the event may be ground construction such as banking or cutting of earth. Alternatively, the event is not limited to the construction and may be, for example, an accident affecting the ground, such as rupture of a water pipe. Alternatively, the event may be a natural disaster, such as heavy rain, flood, earthquake, or extreme weather. Alternatively, the event may be a man-made disaster, such as a large scale fire or an explosion. Alternatively, the event may be a change in the usage status of infrastructures.

The predicted displacement acquired by the predicted displacement acquisition unit 150 is a displacement predicted based on the displacement acquired before the start of the event related to the ground of the structure. The predicted displacement is a displacement of the structure after the start of the event. Hereinafter, “before the start of the event” may be simply referred to as “before the event”. “After the start of the event” may be simply referred to as “after the event”. That is, the term “after the event” includes during and after the occurrence of the event. The displacement before the event is referred to as a “pre-event displacement”. That is, the predicted displacement acquisition unit 150 acquires the predicted displacement predicted for the structure on the ground surface based on the pre-event displacement.

The displacement acquisition unit 160 acquires the displacement of the structure based on an observation result of the ground surface observed after the event. Hereinafter, the displacement of the structure based on the observation result observed after the event is referred to as a “post-event displacement”. For example, the displacement acquisition unit 160 acquires the observation result of the structure after the event from a ground surface observation system. The ground surface observation system is, for example, a system including an observation device that observes the ground surface such as a synthetic aperture rader (SAR). Then, the displacement acquisition unit 160 analyzes the acquired observation result to acquire the post-event displacement of the structure. Alternatively, the displacement acquisition unit 160 may acquire the post-event displacement of the structure from the ground surface observation system. In the following description, these will be collectively described as “the displacement acquisition unit 160 acquires the post-event displacement of the structure on the ground surface”. The ground surface observation system will be further described below.

The effect determination unit 180 determines the effect of the event on the structure based on the predicted displacement and the post-event displacement. The ground of the structure, such as a road, is displaced according to, for example, properties of a geological layer of the ground such as ground sinking. This normal displacement can be predicted to some extent based on the past displacement. On the other hand, in a case where the ground is displaced by the effect of an event, such as tunnel construction, under the ground of the structure, the displacement is often out of the range of the prediction based on the past displacement. Therefore, the effect determination unit 180 determines whether the displacement of the structure has been affected by the event based on the predicted displacement predicted based on the pre-event displacement and the post-event displacement.

Then, the effect determination unit 180 outputs a determination result. For example, the effect determination unit 180 outputs the determination result to a display device or a storage device (not illustrated) such as a terminal device including a liquid crystal display. The display device is not particularly limited as long as the display device can display the determination result.

That is, the effect determination system 11 includes the predicted displacement acquisition unit 150, the displacement acquisition unit 160, and the effect determination unit 180. The predicted displacement acquisition unit 150 acquires the predicted displacement. The predicted displacement is the displacement of the structure on the ground surface and is the displacement of the structure after the event that has been predicted based on the pre-event displacement acquired before the event related to the ground of the structure. The displacement acquisition unit 160 acquires the post-event displacement of the structure based on the observation result of the ground surface observed after the event. The effect determination unit 180 determines the effect of the event on the structure based on the predicted displacement and the post-event displacement.

The displacement of the structure is acquired from analysis of the observation result of the ground surface observation system. However, the analysis using the observation result is not limited to the analysis for acquiring the displacement of the ground surface and includes analysis of, for example, a change in the strength of the ground surface, a factor of the displacement of the ground surface, the magnitude of a risk based on the displacement of the ground surface, and a difference from prediction based on the past displacement of the ground surface. Therefore, the effect determination system 11 may determine the effect of the event using a change in the strength of the ground surface or the like, instead of the displacement on the ground surface. Even in a case where the change in the strength of the ground surface or the like is used instead of the displacement of the ground surface, the displacement acquisition unit 160 may acquire the change in the strength of the ground surface or the like from the ground surface observation system.

In a case where the ground surface observation system performs observation using a plurality of frequencies (multiple spectra), the displacement acquisition unit 160 can acquire the type of the ground surface in addition to the displacement of the ground surface. Therefore, the effect determination system 11 may determine the effect of the event using the type of the ground surface in addition to the displacement of the ground surface. The type of the ground surface that can be acquired is determined according to the frequency to be used. For example, the type of the ground surface includes at least one of a water surface, mud, garbage, dry soil, grassland, forest, farmland, and snow cover. Even in this case, the displacement acquisition unit 160 may acquire the type of the ground surface from the ground surface observation system. However, in the following description, as an example, the effect determination system 11 determines the effect of the event using the displacement of the ground surface.

Examples of a method for analyzing an image of the ground surface include change extraction, time-series interference analysis, coherent change extraction, differential interference analysis, stereo matching, and combinations thereof. Alternatively, as the method for analyzing the image of the ground surface, there is a method that applies a newly acquired image of the ground surface to an analysis model generated by machine learning using the past image of the ground surface and the displacement of the ground surface to analyze the displacement of the ground surface.

As an example of the determination of the effect in the effect determination system 11, a case of tunnel construction under the road will be described. In this description, a structure and the like are as follows.
Structure: road
Event: tunnel construction under the road
Displacement: road sinking

In this case, the predicted displacement acquisition unit 150 acquires, as the predicted displacement, the degree of sinking after the tunnel construction that has been predicted based on the sinking of the road before the tunnel construction. Hereinafter, the degree of sinking after the tunnel construction that has been predicted based on the sinking of the road before the tunnel construction is referred to as “predicted sinking”. The displacement acquisition unit 160 acquires the degree of sinking of the road after the tunnel construction as the post-event displacement. Hereinafter, the degree of sinking after the tunnel construction is referred to as “post-construction sinking”. The effect determination unit 180 determines the effect of the tunnel construction on the road based on the predicted sinking and the post-construction sinking. For example, in a case where the post-construction sinking is equal to or greater than the predicted sinking by prediction accuracy or more, the effect determination unit 180 determines that the sinking of the road has been affected by the tunnel construction. On the other hand, in a case where the post-construction sinking is greater than the predicted sinking, but is within the range of the prediction accuracy or in a case where the post-construction sinking is less than the predicted sinking, the effect determination unit 180 determines that the sinking of the road has not been affected by the tunnel construction.

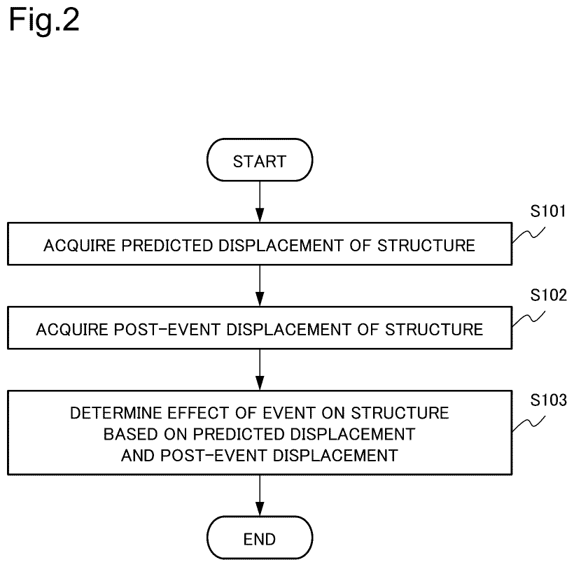

FIG. 2 is a flowchart illustrating an example of the operation of the effect determination system 11 according to the first example embodiment. The predicted displacement acquisition unit 150 acquires the predicted displacement of the structure (step S101). The predicted displacement is a displacement of the structure on the ground surface and is a displacement predicted based on the pre-event displacement acquired before the event related to the ground of the structure. The predicted displacement is a displacement of the structure after the event. The displacement acquisition unit 160 acquires the post-event displacement of the structure (step S102). The effect determination unit 180 determines the effect of the event on the structure based on the predicted displacement and the post-event displacement (step S103).

As described above, the effect determination system 11 determines the effect of the event related to the ground of the structure on the ground surface using the predicted displacement based on the pre-event displacement and the post-event displacement. That is, the effect determination system 11 determines the effect of the event on the structure, using the predicted displacement predicted based on the pre-event displacement, in addition to the post-event displacement that is the displacement acquired based on the observation result of the ground surface observation system or the like. Therefore, the effect determination system 11 can more appropriately determine the effect of the event on the structure.

The displacement used by the effect determination system 11 is, for example, the sinking or upheaval of the structure. However, the displacement used by the effect determination system 11 is not limited to the displacement in the vertical direction with respect to the ground, such as sinking and upheaval, but a displacement including a component in the horizontal direction may be used.

In addition to or instead of the displacement, the predicted displacement acquisition unit 150, the displacement acquisition unit 160, and the effect determination unit 180 of the effect determination system 11 may use at least one of a speed that is a rate of change in the displacement and acceleration that is a rate of change in the speed of the displacement. For example, in a case where the displacement of a certain point increases with the lapse of time, the speed of a change in the displacement is a speed at which the magnitude of the displacement changes. The speed of the displacement and the acceleration of the displacement can be calculated based on the accumulated data.

### Second Example Embodiment

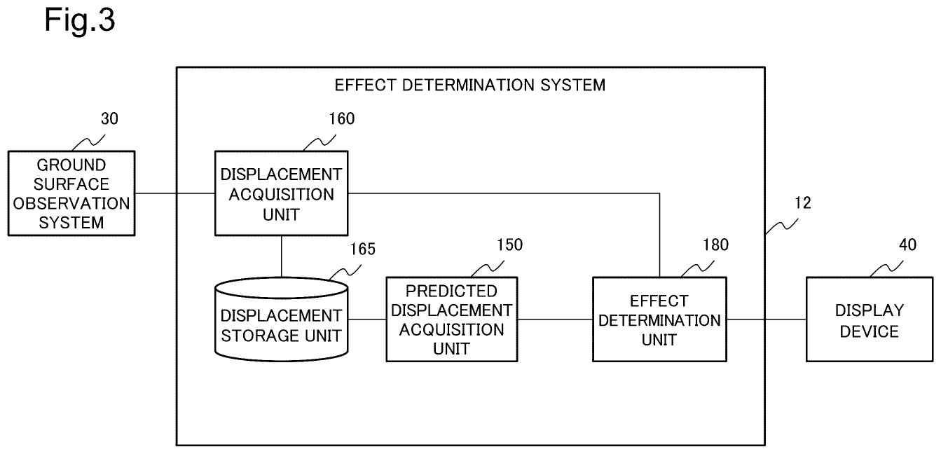

An effect determination system 12 according to a second example embodiment will be described with reference to the drawings. FIG. 3 is a block diagram illustrating an example of a configuration of the effect determination system 12 according to the second example embodiment. In FIG. 3, the effect determination system 12 is connected to a ground surface observation system 30 and a display device 40. The number of components in FIG. 3 is an example and is not limited to the number illustrated in FIG. 3. For example, the effect determination system 12 may be connected to a plurality of ground surface observation systems 30.

### (1) Ground Surface Observation System 30

The ground surface observation system 30 observes a ground surface including a structure using an observation device and outputs an observation result to the effect determination system 12. For example, the ground surface observation system 30 includes an SAR for observing the ground surface including the structure and outputs an image of the ground surface as the observation result. The observation device in the ground surface observation system 30 is, for example, an SAR that is mounted on an artificial satellite, an aircraft, or an unmanned aerial vehicle (drone). However, the observation device is not limited to the SAR and may be, for example, an optical sensor or a laser measurement device. The ground surface observation system 30 may output the observation result using multiple spectra instead of one frequency. The ground surface observation system 30 may analyze the observation result and output an analysis result. For example, the ground surface observation system 30 may output the displacement of the ground surface as the analysis result.

### (2) Effect Determination System 12

The effect determination system 12 includes the predicted displacement acquisition unit 150, the displacement acquisition unit 160, a displacement storage unit 165, and the effect determination unit 180.

### (2-1) Displacement Acquisition Unit 160

The displacement acquisition unit 160 acquires the pre-event displacement and post-event displacement of the structure on the ground surface. For example, the displacement acquisition unit 160 acquires the pre-event displacement and post-event displacement of the structure based on the observation result of the ground surface observation system 30 including the SAR that observes the ground surface including the structure. The displacement acquisition unit 160 may acquire the pre-event displacement and the post-event displacement at each of a plurality of positions. The displacement acquisition unit 160 may acquire the post-event displacement at each of a plurality of time points after the event. The displacement acquisition unit 160 may acquire the pre-event displacement at each of a plurality of time points before the event. Hereinafter, the “pre-event displacement” and the “post-event displacement” may be collectively referred to simply as a “displacement” except a case where they need to be particularly distinguished from each other, in order to avoid complication of description.

The displacement acquisition unit 160 acquires the displacement based on the observation result of the ground surface observed by the ground surface observation system 30. As described above, the displacement is acquired based on the observation result. Therefore, in the following description, the time of observation to be the basis of analysis is used as the time of displacement. The displacement acquisition unit 160 may acquire the displacement based on the observation results at a plurality of time points. For example, the displacement acquisition unit 160 acquires images of the ground surface at two different time points from the ground surface observation system 30. Then, the displacement acquisition unit 160 acquires the displacement of the ground surface between the two time points from analysis using the images of the ground surface at the two different time points. The displacement obtained as the result of the analysis is a displacement from the previous observation to the subsequent observation. Therefore, in this case, the time of the displacement is the time of the subsequent observation.

In a case where the ground surface observation system 30 outputs the displacement of the ground surface as the result of analyzing the observation result, the displacement acquisition unit 160 may acquire the displacement of the ground surface from the ground surface observation system 30. As described above, the displacement acquisition unit 160 may analyze the observation result acquired from the ground surface observation system 30 to acquire the displacement or may acquire the displacement from the ground surface observation system 30. Then, in the following description, these will be collectively described as “the displacement acquisition unit 160 acquires the displacement of the structure on the ground surface from the ground surface observation system 30” as in the first example embodiment.

A method for acquiring the displacement is not limited. Various methods can be assumed as the method for acquiring the displacement. For example, when acquiring the displacement, the displacement acquisition unit 160 may output the position of the structure to the ground surface observation system 30 and acquire the displacement associated to the output position. Alternatively, the displacement acquisition unit 160 may acquire displacements including the displacement of a target structure and the displacements of other structures from the ground surface observation system 30 and extract the displacement of the target structure from the acquired displacements. In a case where the displacement acquisition unit 160 acquires the displacements at a plurality of positions, detection ranges of at least some displacements may overlap each other. Alternatively, the displacement acquisition unit 160 may acquire the displacements stored in a storage device (not illustrated) as the at least some displacements.

In a case where the structure is wider than the spatial resolution of the displacement, the displacements at the plurality of positions are the displacements associated to the structure. Therefore, in a case where the structure is wider than the spatial resolution of the displacement, the displacement acquisition unit 160 may acquire the displacement at each of the plurality of positions associated to the structure in such a way as to cover the entire structure. The spatial resolution is the minimum distance at which two objects at a close distance can be distinguished as two objects. For example, the spatial resolution of the displacement is the minimum distance between two displacements.

The displacement acquisition unit 160 may acquire the displacement of a partial range of the structure. For example, in a case where the structure is a road, the displacement acquisition unit 160 may acquire a displacement related to the road designated in advance. Alternatively, in a case where the range in which the event has occurred is specified, the displacement acquisition unit 160 may acquire the displacement in the range in which the event has occurred.

Then, the displacement acquisition unit 160 stores the pre-event displacement in the displacement storage unit 165. The displacement acquisition unit 160 outputs the post-event displacement to the effect determination unit 180. The displacement acquisition unit 160 may store the post-event displacement in the displacement storage unit 165. Alternatively, the displacement acquisition unit 160 may output the pre-event displacement to the effect determination unit 180.

### (2-2) Displacement Storage Unit 165

The displacement storage unit 165 stores the pre-event displacement acquired by the displacement acquisition unit 160. In a case where the pre-event displacements at a plurality of time points are stored, the displacement storage unit 165 may store the pre-event displacements as a history. In a case where the displacement acquisition unit 160 acquires the pre-event displacements at a plurality of positions, the displacement storage unit 165 may store the pre-event displacement at each of the plurality of positions. Then, the displacement storage unit 165 outputs the pre-event displacement to the predicted displacement acquisition unit 150. In a case where the post-event displacement is stored, the displacement storage unit 165 may output the post-event displacement to the effect determination unit 180.

### (2-3) Predicted Displacement Acquisition Unit 150

The predicted displacement acquisition unit 150 acquires the predicted displacement based on the pre-event displacement stored in the displacement storage unit 165. For example, the predicted displacement acquisition unit 150 may apply the pre-event displacement to a prediction model acquired from machine learning using the past displacements to acquire the predicted displacement. However, the method by which the predicted displacement acquisition unit 150 acquires the predicted displacement is not limited thereto. For example, the predicted displacement acquisition unit 150 may apply the pre-event displacement to a predetermined prediction expression to acquire the predicted displacement. Alternatively, the predicted displacement acquisition unit 150 may output the pre-event displacement to a configuration or a device (not illustrated) and acquire the predicted displacement from the configuration or the device. For example, the predicted displacement acquisition unit 150 acquires the predicted displacement of the structure after tunnel construction based on the pre-event displacement acquired before the tunnel construction. In a case where the displacement storage unit 165 stores the pre-event displacements at a plurality of positions, the predicted displacement acquisition unit 150 may acquire the pre-event displacement at each of the plurality of positions.

The predicted displacement acquisition unit 150 acquires a predicted displacement at a specified time point as the predicted displacement to be acquired. Hereinafter, the specified time point is referred to as a “time point of prediction”. The time point of prediction used by the predicted displacement acquisition unit 150 is not limited. For example, the predicted displacement acquisition unit 150 may use a preset time point or a time point designated by the user as the time point of prediction of the predicted displacement. Alternatively, the predicted displacement acquisition unit 150 may use the time of observation used to acquire the post-event displacement, that is, the time of the post-event displacement, as the time point of prediction. The predicted displacement acquisition unit 150 may acquire the predicted displacement at each of a plurality of time points after the event instead of one time point.

### (2-4) Effect Determination Unit 180

The effect determination unit 180 determines the effect of the event on the structure based on the predicted displacement and the post-event displacement. For example, in a case where the post-event displacement is larger than the predicted displacement by a predetermined value or more, the effect determination unit 180 determines that the event affects the structure. The predetermined value may be appropriately determined according to, for example, a structure, errors in the determination and prediction of the displacement, and the like. For example, in a case where the event is tunnel construction, the effect determination unit 180 compares predicted sinking with post-construction sinking in the range of the tunnel construction. Then, in a case where the post-construction sinking is larger than the predicted sinking, the effect determination unit 180 determines that there is an effect of the tunnel construction. The effect determination unit 180 may determine that there is the effect of the tunnel construction in consideration of the errors in the prediction and the determination in a case where the post-construction sinking is larger than the predicted sinking by a predetermined value or more.

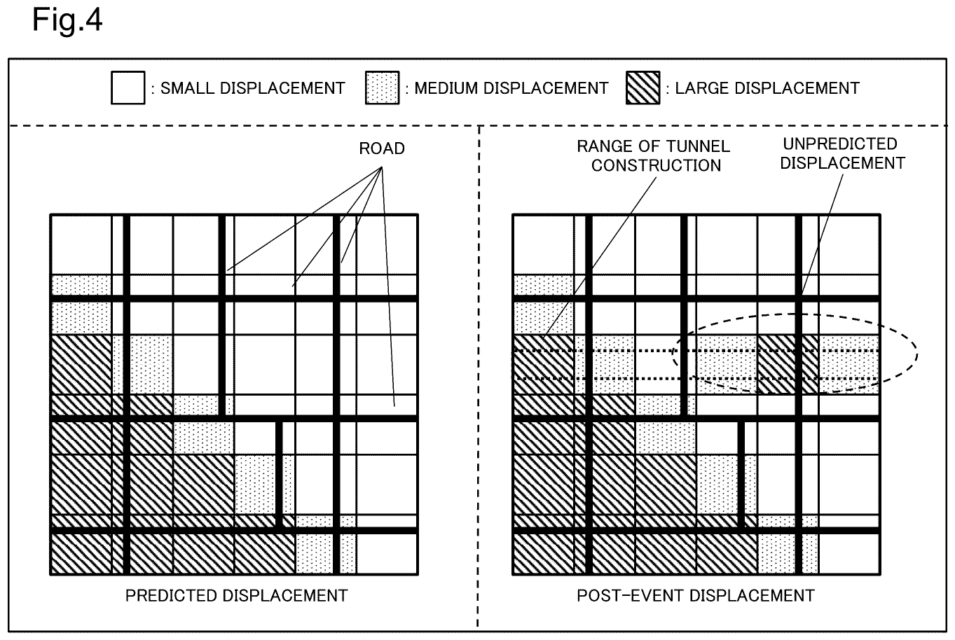

The effect determination unit 180 may determine the range affected by the event. For example, the effect determination unit 180 may determine a range in which the post-event displacement is larger than the predicted displacement by a predetermined value or more as the range affected by the event. For example, in the range of the tunnel construction, the effect determination unit 180 may determine a range in which the post-event displacement is larger than the predicted displacement by a predetermined value or more as the range affected by the tunnel construction. FIG. 4 is a diagram illustrating an example of the range determined to be affected by the event. The left side of FIG. 4 is the predicted displacement. The right side of FIG. 4 is the post-event displacement. In a case where the displacements illustrated on the left and right sides of FIG. 4 are compared, a displacement in a range surrounded by a broken line in an upper portion of the post-event displacement on the right side of FIG. 4 is an unpredicted displacement and is the range of the tunnel construction. Therefore, the effect determination unit 180 determines this range as the range affected by the tunnel construction. The effect determination unit 180 may determine the range that is not affected by the event. For example, the effect determination unit 180 may determine a range in which the post-event displacement is larger than the predicted displacement and a difference therebetween is less than a predetermined value and a range in which the post-event displacement is less than the predicted displacement as the ranges not affected by the tunnel construction. The classification of the displacements is not limited to “large, medium, and small” illustrated in FIG. 4 and may be performed using any scale. For example, the displacements may be classified in increments of 1 mm.

The effect determination unit 180 may determine the effect of the event based on a relationship between the predicted displacements and the post-event displacements at a plurality of positions. For example, in a case where the predicted displacement acquisition unit 150 acquires the predicted displacements at a plurality of positions and the displacement acquisition unit 160 acquires the post-event displacements at a plurality of positions, the effect determination unit 180 may determine the effect of the event based on the predicted displacement and the post-event displacement at each of the plurality of positions. The effect determination unit 180 may determine the effect of the event based on the post-event displacement, the predicted displacement, and the range of the event. As an example, a case where sinking is used as the displacement will be described. For example, in a case where the range in which post-construction sinking is larger than predicted sinking substantially overlaps the range of construction and is similar to the range of the construction, there is a high possibility that the sinking has occurred under the effect of the construction. Therefore, in this case, the effect determination unit 180 may determine that the sinking is affected by the construction. As described above, in a case where the post-event displacements and the predicted displacements at a plurality of positions are used, the effect determination unit 180 can more appropriately determine the effect of the event.

Alternatively, the effect determination unit 180 may determine the effect of the event using the gradient of the displacement calculated from the displacements at a plurality of positions. In a case where the gradient is used, the effect determination unit 180 may use the direction of the gradient for the determination. For example, the effect determination unit 180 acquires the gradient of the predicted displacement based on the predicted displacements at a plurality of positions. Hereinafter, the gradient of the predicted displacement is referred to as a “predicted gradient”. The effect determination unit 180 acquires the gradient of the post-event displacement based on the post-event displacements at a plurality of positions. Hereinafter, the gradient of the displacement acquired based on the post-event displacement is referred to as a “post-event gradient”. Then, the effect determination unit 180 may determine the effect of the event based on the predicted gradient and the post-event gradient. For example, in a case where the positions where a difference between the predicted gradient and the post-event gradient is large are arranged along a progress direction of the event, such as a progress direction of the tunnel construction, the effect determination unit 180 may determine that there is the effect of the event.

The direction of the gradient used for the determination may be a direction different from the progress direction of the event. For example, the effect determination unit 180 may determine the effect of the event based on the predicted gradient and the post-event gradient in a direction orthogonal to the progress direction of the event. For example, in a case where the difference between the predicted gradient and the post-event gradient in a width direction of the tunnel construction increases from a peripheral portion toward a central portion of the tunnel construction, the effect determination unit 180 may determine that there is the effect of the event. Alternatively, the gradient direction is not limited to one direction. For example, the effect determination unit 180 may determine the effect of the event based on the predicted gradient and the post-event gradient in at least a portion of the entire range of the construction.

The effect determination unit 180 may determine the effect of the event based on the relationship between the predicted displacements and the post-event displacements at a plurality of time points or changes in the predicted displacements and the post-event displacements over time. For example, in a case where the predicted displacement acquisition unit 150 acquires the predicted displacements at a plurality of time points and the displacement acquisition unit 160 acquires the post-event displacements at a plurality of time points, the effect determination unit 180 may determine the effect of the event based on the predicted displacement and the post-event displacement at each of the plurality of time points. For example, in a case where the difference between the predicted sinking and the post-construction sinking increases with the lapse of a plurality of time points after the event, the effect determination unit 180 may determine that the sinking is affected by the construction.

The effect determination unit 180 may determine the effect of the event based on the relationship between the predicted displacements and the post-event displacements at a plurality of positions and a plurality of time points and changes in the predicted displacements and the post-event displacements over time. For example, in a case where the range in which the difference between the predicted sinking and the post-construction sinking is large expands in an excavation direction of the tunnel construction with the progress of the tunnel construction, there is a high possibility that the sinking will be affected by the tunnel construction. Therefore, in a case where the range in which the difference between the predicted sinking and the post-construction sinking is large expands in the excavation direction of the tunnel construction as the tunnel construction progresses with the lapse of time, the effect determination unit 180 may determine that the sinking is affected by the construction.

The effect determination unit 180 may use other information in the determination of the effect. For example, in the determination of the effect, the effect determination unit 180 may use at least one of a geological layer of the ground of the structure, a range in which the event has occurred, a topography around the structure, a geology, soil, weather, a construction type, and a construction method. Examples of the topography include artificial flat land, cut land, reclaimed land, fill-up land, and a gravel collection site. Examples of the geology include soil, a sedimentary rock, an igneous rock, lava, a metamorphic rock, and a mineral vein. The examples of the weather include fine rain, temperature, humidity, precipitation, and snow accumulation. Examples of the construction type include civil engineering works, architectural works, paving works, and water facility works. Examples of the construction method include a shield method, a tunnel boring machine (TBM) method, and a new Austrian tunneling method (NATM).

Then, the effect determination unit 180 outputs the determination result. For example, the effect determination unit 180 outputs the determination result to the display device 40 or the like. The display device 40 is not particularly limited as long as it is a device that displays the determination result. The content of the determination result output by the effect determination unit 180 is not particularly limited. For example, the effect determination unit 180 may output a determination result for the entire structure as the determination result. Alternatively, the effect determination unit 180 may output a determination result of a portion of the structure. For example, the effect determination unit 180 may output, as the determination result, a determination result of the range determined to be affected by the event. The effect determination unit 180 may output at least one of the predicted displacement and the post-event displacement. For example, the effect determination unit 180 may output the determination result of the range determined to be affected by the event, the predicted displacement, and the post-event displacement.

### (2-5) Effect Determination System 12

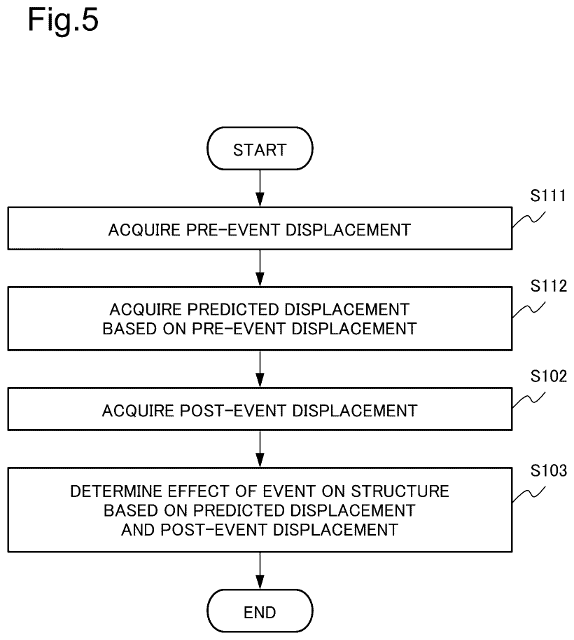

An operation of the effect determination system 12 will be described with reference to the drawings. FIG. 5 is a flowchart illustrating an example of the operation of the effect determination system 12 according to the second example embodiment. The displacement acquisition unit 160 acquires the pre-event displacement (step S111). Then, the displacement acquisition unit 160 stores the pre-event displacement in the displacement storage unit 165. The predicted displacement acquisition unit 150 acquires the predicted displacement based on the pre-event displacement (step S112). The displacement acquisition unit 160 acquires the post-event displacement (step S102). The effect determination unit 180 determines the effect of the event on the structure based on the predicted displacement and the post-event displacement (step S104).

The effect determination system 12 may repeat the following operation according to a management cycle of the structure. The displacement acquisition unit 160 reacquires the post-event displacement. The predicted displacement acquisition unit 150 reacquires the predicted displacement at the time associated to the post-event displacement. Then, the effect determination unit 180 redetermines the effect of the event based on the reacquired predicted displacement and post-event displacement. In this case, for the next operation, the displacement acquisition unit 160 may add the reacquired post-event displacement to the pre-event displacement. In this case, the predicted displacement acquisition unit 150 may use the pre-event displacement to which the currently acquired post-event displacement has been added in the acquisition of the next predicted displacement.

Alternatively, the effect determination system 12 may repeat the operation according to a predetermined cycle such as every month or week or an observation cycle used for analyzing the displacement. Alternatively, the effect determination system 12 may repeat the operation according to an instruction from the user. Similarly to the effect determination system 11, the effect determination system 12 may use at least one of a speed that is a rate of change in the displacement and acceleration that is a rate of change in the speed of the displacement in addition to or instead of the displacement.

### (3) Display Device

The display device 40 displays the determination result related to the effect of the event from the effect determination unit 180. For example, the display device 40 may display the determination result of the effect of the tunnel construction on the road as illustrated on the right side of FIG. 4. As described above, the type, installation location, and the like of the display device 40 are not important as long as the display device 40 can display the determination result. The relationship between the effect determination system 12 and the display device 40 is not particularly limited.

### Third Example Embodiment

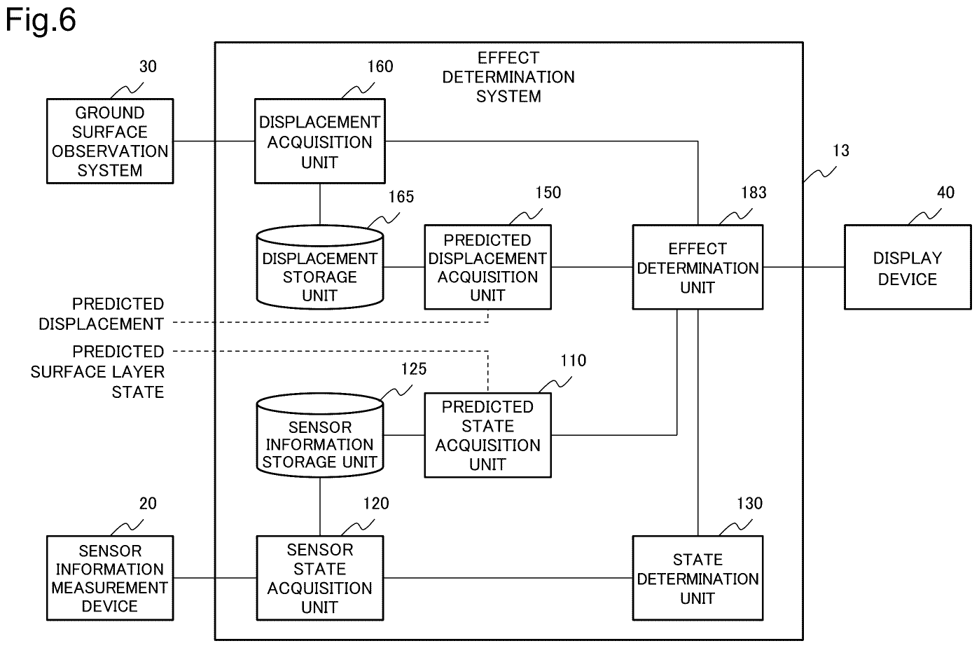

An effect determination system 13 according to a third example embodiment will be described with reference to the drawings. FIG. 6 is a block diagram illustrating an example of a configuration of the effect determination system 13 according to the third example embodiment. In FIG. 6, the effect determination system 13 is further connected to a sensor information measurement device 20 as compared to the effect determination system 12. Therefore, hereinafter, the sensor information measurement device 20 and the effect determination system 13 will be mainly described.

### (1) Sensor Information Measurement Device 20

The sensor information measurement device 20 measures sensor information related to a surface of a structure. For example, the sensor information measurement device 20 is mounted on or pulled by a moving object that moves on an upper surface of the structure or in the vicinity of the structure and measures the sensor information related to the surface of the structure. For example, the sensor information measurement device 20 is a dashboard camera (dashcam) that is mounted on a vehicle as an example of the moving object and that measures an image of a road as an example of the sensor information. Alternatively, the sensor information measurement device 20 may be a vibration meter that measures vibration of the vehicle or an acceleration meter that measures the acceleration of the vibration of the vehicle. However, the sensor information measurement device 20 is not limited to the dashcam, the vibration meter, and the acceleration meter mounted on the vehicle. For example, the sensor information measurement device 20 may be a fixed device, such as a fixed camera, which is installed on a road or beside the road. The sensor information measurement device 20 may be a device capable of changing performance related to the measurement of the sensor information such as an imaging direction and a focal length.

The moving object equipped with the sensor information measurement device 20 is not limited to the vehicle. For example, an unmanned aerial vehicle (drone) may be equipped with the sensor information measurement device 20 and moved. Alternatively, a person may carry the sensor information measurement device 20 like a wearable dashcam.

The sensor information measured by the sensor information measurement device 20 is information related to the surface of the structure. For example, the sensor information is the image of the surface of the structure such as the image of the surface of the road. However, the sensor information is not limited to the image. For example, the sensor information may be the magnitude, speed, or acceleration of the vibration occurring due to unevenness of the road surface. Alternatively, the sensor information may be three-dimensional data such as data measured using radio detecting and ranging (RADAR) or light detection and ranging (LiDAR). The sensor information may include not one information item but a plurality of information items such as a combination of the image and the acceleration. In the following description, as an example, the dashcam is used as the sensor information measurement device 20, and the image of the surface of the structure is used as the sensor information. A vehicle is used as an example of the moving object.

Other information may be attached to the sensor information. Hereinafter, examples of the information attached to the sensor information will be described.

### Identification Information

Information for identifying the sensor information may be attached to the sensor information. For example, an identifier may be attached to the sensor information. Alternatively, in a case where the sensor information is measured at a plurality of positions, the position where the sensor information has been measured may be attached to the sensor information. The position may be a two-dimensional position, such as latitude and longitude, or may be a three-dimensional position including height. Alternatively, in a case where the sensor information is measured at a plurality of time points, the time when the sensor information has been measured may be attached to the sensor information. For example, the effect determination system 13 may identify the sensor information, using the position and the time included in the sensor information. As described above, the position and the time attached to the sensor information may be used to identify the sensor information.

### Measurement Device Information

Information that affects the measured sensor information may be attached to the sensor information. For example, information related to the sensor information measurement device 20 may be attached to the sensor information. For example, the information related to the sensor information measurement device 20 may include at least one of the device name, model name, attachment position, and imaging direction of the sensor information measurement device 20. Alternatively, information related to a sensor of the sensor information measurement device 20 may be attached to the sensor information. For example, the information related to the sensor may include at least one of the type, specifications, and performance of the sensor. For example, in a case where the sensor is a camera, the information related to the sensor may include at least one of the focal length, aperture, diaphragm, shutter speed, and number of pixels of the camera.

### Moving Object Information

In a case where the sensor information measurement device 20 is mounted on the moving object, information related to the moving object may be attached to the sensor information. For example, the information related to the moving object may include at least one of the name, model number, and type of the moving object. Alternatively, information related to the operation of the moving object may be attached to the sensor information. For example, in a case where the moving object is a vehicle, the information related to the operation of the moving object may include operation information of at least one of an accelerator pedal, a brake pedal, a shift lever, a steering wheel, a wiper, a blinker, and the opening and closing of a door.

### Peripheral Information

Peripheral information when the sensor information is measured may be attached to the sensor information. The peripheral information may include, for example, at least one of surrounding weather, temperature, humidity, illuminance, a degree of congestion, and voice.

### Worker Information

Information related to a worker who is in charge of measuring the sensor information may be attached to the sensor information. For example, the information related to the worker may include at least one of the name and identifier of the worker. Alternatively, information added by the worker may be attached to the sensor information. For example, the information added by the worker may include comments related to at least one of the structure and the sensor information.

### (2) Effect Determination System 13

The effect determination system 13 includes an effect determination unit 183 instead of the effect determination unit 180 in the same configuration as that of the effect determination system 12 and further includes a sensor information acquisition unit 120, a sensor information storage unit 125, a predicted state acquisition unit 110, and a state determination unit 130. Therefore, in the following description, configurations and operations different from those of the second example embodiment will be mainly described, and a description of the same configurations and operations as those of the second example embodiment will be appropriately omitted. The predicted displacement acquisition unit 150 may acquire the predicted displacement as in the first example embodiment or may acquire the predicted displacement based on the displacement stored in the displacement storage unit 165 as in the second example embodiment.

### (2-1) Sensor Information Acquisition Unit 120

The sensor information acquisition unit 120 acquires sensor information measured before the event and sensor information measured after the event. Hereinafter, the sensor information measured before the event is referred to as “pre-event sensor information”. The sensor information measured after the event is referred to as “post-event sensor information”. That is, the sensor information acquisition unit 120 acquires the pre-event sensor information and the post-event sensor information. For example, the sensor information acquisition unit 120 acquires the pre-event sensor information and the post-event sensor information related to the surface of the structure that has been acquired by the sensor information measurement device 20 mounted on the moving object. The sensor information acquisition unit 120 may acquire the pre-event sensor information and the post-event sensor information at each of a plurality of positions. The sensor information acquisition unit 120 may acquire the post-event sensor information at each of a plurality of time points after the event. The sensor information acquisition unit 120 may acquire the pre-event sensor information at each of a plurality of time points before the event. Hereinafter, the “pre-event sensor information” and the “post-event sensor information” may be collectively referred to simply as “sensor information” except a case where they need to be particularly distinguished from each other, in order to avoid complication of description. The sensor information acquisition unit 120 may acquire the time when the sensor information has been measured. Hereinafter, the time when the sensor information has been measured is referred to as “time of the sensor information”.

A method for acquiring the sensor information is not limited. Various methods can be assumed as the method for acquiring the sensor information. For example, the sensor information acquisition unit 120 may output the position of the structure to the sensor information measurement device 20 and acquire the sensor information associated to the output position. Alternatively, the sensor information acquisition unit 120 may acquire sensor information items including sensor information of a target structure and sensor information items of other structures from the sensor information measurement device 20 and extract sensor information associated to the position of the structure from the acquired sensor information items. The sensor information acquisition unit 120 may acquire the pre-event sensor information and the post-event sensor information at each of a plurality of positions associated to the structure in such a way as to cover the entire structure.

Alternatively, the sensor information acquisition unit 120 may acquire the sensor information in a partial range of the structure. For example, in a case where the structure is a road, the sensor information acquisition unit 120 may acquire sensor information related to the road designated in advance. Alternatively, in a case where the range in which the event has occurred is specified, the sensor information acquisition unit 120 may acquire the sensor information of the range in which the event has occurred.

In a case where the sensor information acquisition unit 120 acquires sensor information items at a plurality of positions, detection ranges of at least some of the sensor information items may overlap each other. Alternatively, the sensor information acquisition unit 120 may acquire sensor information stored in a storage device (not illustrated) as the at least some sensor information items. In a case where the effect determination system 13 is connected to a plurality of sensor information measurement devices 20, the sensor information acquisition unit 120 may acquire sensor information from the plurality of sensor information measurement devices 20. In this case, the sensor information acquisition unit 120 may acquire the pre-event sensor information and the post-event sensor information from different sensor information measurement devices 20.

Then, the sensor information acquisition unit 120 stores the pre-event sensor information in the sensor information storage unit 125. The sensor information acquisition unit 120 outputs the post-event sensor information to the state determination unit 130. The sensor information acquisition unit 120 may store the post-event sensor information in the sensor information storage unit 125. Alternatively, the sensor information acquisition unit 120 may output the pre-event sensor information to the state determination unit 130.

### (2-2) Sensor Information Storage Unit 125

The sensor information storage unit 125 stores the pre-event sensor information acquired by the sensor information acquisition unit 120. In a case where the pre-event sensor information items at a plurality of time points are stored, the sensor information storage unit 125 may store the pre-event sensor information items as a history. In a case where the sensor information acquisition unit 120 acquires the pre-event sensor information items at a plurality of positions, the sensor information storage unit 125 may store the pre-event sensor information at each of the plurality of positions. Then, the sensor information storage unit 125 outputs the pre-event sensor information to the predicted state acquisition unit 110. In a case where the post-event sensor information is stored, the sensor information storage unit 125 may output the post-event sensor information to the state determination unit 130.

### (2-3) Predicted State Acquisition Unit 110

The predicted state acquisition unit 110 acquires a predicted surface layer state of the structure after the event that is sensor information related to the surface of the structure and that has been predicted based on the sensor information measured before the event. For example, the predicted state acquisition unit 110 acquires the predicted surface layer state after the event based on the pre-event sensor information stored in the sensor information storage unit 125. Hereinafter, the surface layer state predicted based on the pre-event sensor information is referred to as a “predicted surface layer state”. For example, the predicted state acquisition unit 110 may apply the pre-event sensor information to a prediction model acquired from machine learning using the past sensor information and surface layer state to acquire the predicted surface layer state. Alternatively, the predicted state acquisition unit 110 may apply the pre-event sensor information to a predetermined prediction expression to acquire the predicted surface layer state. Alternatively, the predicted state acquisition unit 110 may acquire the predicted surface layer state from an external device (not illustrated). For example, the predicted state acquisition unit 110 may output the pre-event sensor information to a configuration or a device (not illustrated) and acquire the predicted surface layer state from the configuration or the device. Specifically, for example, the predicted state acquisition unit 110 acquires a crack rate after tunnel construction that has been predicted based on the image of the road measured before the tunnel construction. In a case where the sensor information storage unit 125 stores the pre-event sensor information items at a plurality of positions, the predicted state acquisition unit 110 may acquire the predicted surface layer states at the plurality of positions.

The predicted state acquisition unit 110 acquires a surface layer state at a certain specified time point as the predicted surface layer state to be acquired. Hereinafter, the specified time point is referred to as a “time point of prediction”. The time point of prediction used by the predicted state acquisition unit 110 is not limited. For example, the predicted state acquisition unit 110 may use a preset time point or a time point designated by the user as the time point of prediction. Alternatively, the predicted state acquisition unit 110 may use the time when the post-event sensor information acquired by the sensor information acquisition unit 120 has been measured as the time point of prediction. That is, the predicted state acquisition unit 110 may acquire the predicted surface layer state at a time point associated to the time of the post-event sensor information. The predicted state acquisition unit 110 may acquire the predicted surface layer state at each of a plurality of time points after the event instead of one time point.

The predicted state acquisition unit 110 may acquire the predicted surface layer state based on the surface layer state determined based on the sensor information measured before the event, instead of the pre-event sensor information. Hereinafter, the surface layer state determined based on the sensor information measured before the event is referred to as a “pre-event surface layer state”. For example, the predicted state acquisition unit 110 may acquire the predicted surface layer state based on the pre-event surface layer state determined by the state determination unit 130 based on the stored pre-event sensor information. Even in this case, the predicted state acquisition unit 110 may acquire the predicted surface layer state using a predetermined prediction model or prediction expression. Alternatively, the predicted state acquisition unit 110 may acquire the predicted surface layer state using a configuration or a device (not illustrated).

The “surface layer” of the structure is a range in which the state can be checked from the surface of the structure. The surface of the structure is not limited to the road surface through which a vehicle or the like passes and may be a surface in contact with the outside, such as a side wall and a ceiling of a tunnel. For example, the surface layer is a portion including a surface and a range from the surface to a predetermined depth. For example, in a case where the structure includes a plurality of layers, the surface layer is a layer of the surface of the structure or a predetermined layer including the layer of the surface. Hereinafter, a portion excluding the surface layer of the structure is referred to as a “deep layer”. For example, in a case where the structure is an asphalt-paved road, the surface layer is a layer of asphalt. In this case, for example, the deep layer is a crushed stone layer, a road bed, and a road body. However, the surface layer and the deep layer are not limited to the above. For example, in a case where the structure is an asphalt-paved road, the surface layer may be an asphalt layer and a crushed stone layer. In this case, the deep layer is a road bed and a road body.

The “surface layer state” is a state of the surface layer of the structure. For example, the “surface layer state” is determined based on the sensor information. For example, the determined surface layer state is deterioration related to the road. The deterioration of the road is, for example, at least one of a crack, a rut, a pothole, deterioration of a road surface seal, and fraying of a peripheral portion of the seal. The surface layer state may be a type of deterioration. For example, the surface layer state may be a type of deterioration such as a vertical crack, a horizontal crack, or an alligator crack. Alternatively, the surface layer state may be deterioration of an object that is provided on the surface of the road, such as scratching of a white line of the road surface and a road surface sign or breakage of a sign. Alternatively, the surface layer state may be a change in the surface, such as abrasion of the surface layer, instead of breakage such as a crack. Alternatively, the surface layer state may be a state of a processed portion of the road surface such as a straight groove for drainage in the road surface or a circular groove for slip prevention in a slope. Alternatively, a “deterioration degree” that is a degree of deterioration may be used as the surface layer state. General deterioration degrees on roads, runways, and the like include the following.
Crack rate: a value obtained by dividing the area of a crack by the area of an object to be investigated.
Amount of rutting: a height from a rutting portion to a protrusion in a predetermined range. In many cases, 20 m is used as the predetermined range.
International Roughness Index (IRI): an evaluation index for unevenness of a paved road proposed by the World Bank in 1986.
Boeing Bump Index (BBI): a flatness index adopted by the Federal Aviation Administration in 2009.

### (2-4) State Determination Unit 130

The state determination unit 130 determines the surface layer state of the structure after the event based on the post-event sensor information. Specifically, the state determination unit 130 determines a deterioration state of the surface layer. Hereinafter, the surface layer state of the structure after the event is referred to as a “post-event surface layer state”. For example, the state determination unit 130 may acquire the post-event sensor information from the sensor information acquisition unit 120 and determine the post-event surface layer state based on the acquired post-event sensor information. Alternatively, when determining the post-event surface layer state, the state determination unit 130 may acquire the post-event sensor information from the sensor information acquisition unit 120 or may acquire the post-event sensor information stored in the sensor information storage unit 125. In a case where the sensor information acquisition unit 120 acquires the post-event sensor information items at a plurality of positions, the state determination unit 130 may determine the post-event surface layer state at each of the plurality of positions.

The state determination unit 130 may determine the post-event surface layer state based on the post-event sensor information measured at the designated time. For example, the state determination unit 130 may acquire the post-event sensor information at the time designated by the user from the sensor information storage unit 125 and determine the post-event surface layer state based on the acquired post-event sensor information. In a case where the sensor information acquisition unit 120 acquires the post-event sensor information items at a plurality of time points after the event, the state determination unit 130 may determine the post-event surface layer state at each of the plurality of time points based on the post-event sensor information at each of the plurality of time points after the event.

### (2-5) Effect Determination Unit 183

The effect determination unit 183 determines the effect of the event on the structure, similarly to the effect determination unit 180. However, the effect determination unit 183 determines the effect of the event on the structure based on the predicted surface layer state and the post-event surface layer state in addition to the predicted displacement and the post-event displacement. For example, the effect determination unit 183 may use a crack rate after tunnel construction that has been predicted based on the image of the road before the tunnel construction and a crack rate determined based on the image of the road after the tunnel construction, in addition to the predicted sinking and the post-construction sinking. Hereinafter, the crack rate after the tunnel construction predicted based on the image of the road before the tunnel construction is referred to as a “predicted crack rate”. Hereinafter, the crack rate determined based on the image of the road after the tunnel construction is referred to as a “post-construction crack rate”. Specifically, for example, the effect determination unit 183 may determine that there is an effect of the construction in a case where both the difference between the predicted sinking and the post-event sinking and the difference between the predicted crack rate and the post-construction crack rate are large.

The effect determination unit 183 may determine the effect of the event based on the relationship between the predicted displacements and the post-event displacements at a plurality of positions. For example, the effect determination unit 183 may use the predicted surface layer state and the post-event surface layer state at each of the plurality of positions. The effect determination unit 183 may determine the effect of the event based on the relationship between the predicted surface layer state and the post-event surface layer state at each of a plurality of time points or changes in the predicted displacement and the post-event displacement over time. For example, in a case where the difference between the predicted surface layer state and the post-event surface layer state increases with the lapse of the plurality of time points after the event, the effect determination unit 183 may determine that the displacement is affected by the construction. The effect determination unit 183 may determine the effect of the event based on the relationship between the predicted surface layer states and the post-event surface layer states at a plurality of positions and a plurality of time points and changes in the predicted surface layer states and the post-event surface layer states over time. For example, in a case where the range in which the difference between the predicted crack rate and the post-event crack rate is large expands with the progress of the event, the effect determination unit 183 may determine that the structure is affected by the event.

The effect determination unit 183 may output at least one of the sensor information and the surface layer state in addition to the determination result. For example, the effect determination unit 183 may output the determination result of the range determined to be affected by the event, the predicted surface layer state, and the post-event surface layer state. Alternatively, the effect determination unit 183 may output the determination result of the range determined to be affected by the event, the pre-event sensor information, and the post-event sensor information.

A repair work of the road where a crack and the like occur, but sinking does not occur is a repair work of a surface layer such as an asphalt layer. On the other hand, a repair work of the road where a crack does not occur, but sinking occurs is a repair work of a deep layer such as a road bed or a subgrade. Alternatively, there is a possibility that subsidence or the like will occur in the near future in the road where deterioration, such as a crack, does not occur, but sinking is progressing faster than predicted. Therefore, the user may close off the portion in advance or perform a repair work of the portion in advance. As described above, in a case where a change in any one of the surface layer state and the displacement is large, measures, such as repair works related to the portion, may be different. That is, the information of the position or range where it is determined that one of the surface layer state and the displacement has been affected by the event is useful for the user.

Therefore, the effect determination unit 183 may output the position or range where it is determined that a change in any one of the surface layer state and the displacement is large. For example, the effect determination unit 183 may output a range in which the difference between the predicted crack rate and the post-event crack rate is large and the difference between the predicted displacement and the post-event displacement is small. Alternatively, the effect determination unit 183 may output a range in which the difference between the predicted crack rate and the post-event crack rate is small and the difference between the predicted displacement and the post-event displacement is large.

### (2-6) Effect Determination System 13

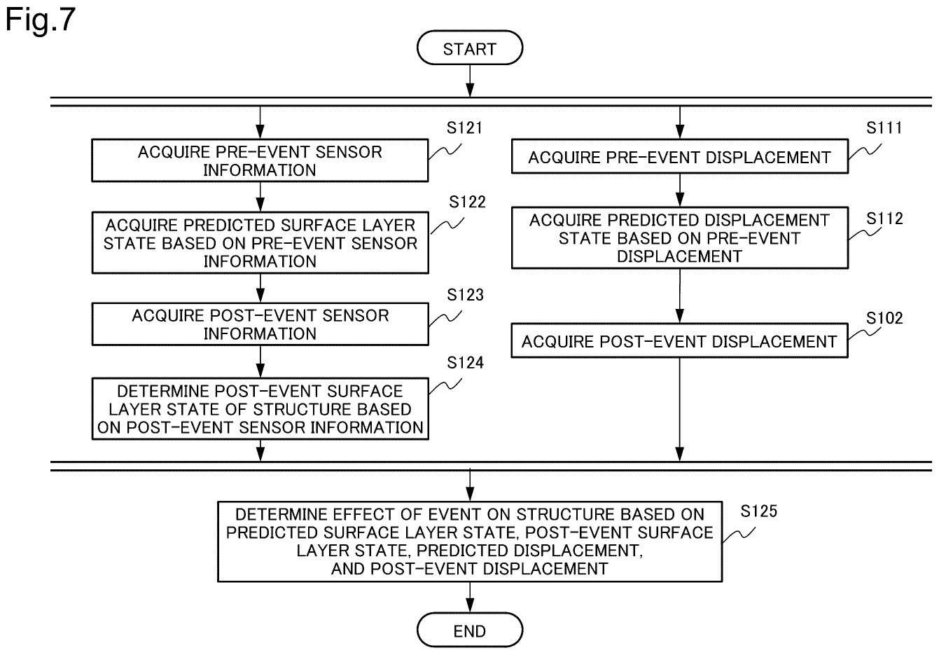

FIG. 7 is a flowchart illustrating an example of the operation of the effect determination system 13 according to the third example embodiment. The displacement acquisition unit 160 acquires the pre-event displacement. (step S111). Then, the displacement acquisition unit 160 stores the pre-event displacement in the displacement storage unit 165. The predicted displacement acquisition unit 150 acquires the predicted displacement based on the pre-event displacement (step S112). The displacement acquisition unit 160 acquires the post-event displacement (step S102). The sensor information acquisition unit 120 acquires the pre-event sensor information (step S121). Then, the sensor information acquisition unit 120 stores the pre-event sensor information in the sensor information storage unit 125. The predicted state acquisition unit 110 acquires the predicted surface layer state based on the pre-event sensor information (step S122). The sensor information acquisition unit 120 further acquires the post-event sensor information (step S123). The state determination unit 130 determines the post-event surface layer state of the structure based on the post-event sensor information (step S124). The effect determination unit 183 determines the effect of the event on the structure based on the predicted surface layer state, the post-event surface layer state, the predicted displacement, and the post-event displacement (step S125). Either the operation in steps S111 to S102 or the operation in steps S121 to S124 may be executed first. Similarly to the effect determination system 12, the effect determination system 13 may repeat the operation every time a predetermined condition is satisfied.

In general, the spatial resolution of the displacement is in a wide range to some extent. For example, in many cases, the spatial resolution of the SAR is a few meters at most. On the other hand, the spatial resolution of the surface layer state determined using the sensor information is about several centimeters to several tens of centimeters. The spatial resolution of the surface layer state is the minimum distance between two surface layer states determined using the sensor information. Then, the effect determination system 13 determines the effect of the event based on the displacement and the surface layer state. Therefore, the effect determination system 13 can implement determination with higher spatial resolution than the displacement.

In general, in many cases, the observation cycle on which the displacement is analyzed is longer than the measurement cycle of the sensor information used to determine the surface layer state. That is, in many cases, the measurement time of the sensor information used for the determination is closer to the observation time used to determine the displacement on average. Therefore, the effect determination system 13 can implement the determination using information temporally closer than the displacement on average, using the surface layer state.

However, the sensor information measurement device 20 measures sensor information in a range in which the moving object having the sensor information measurement device 20 mounted thereon can move. For example, in a case where the sensor information measurement device 20 is a dashcam mounted on a vehicle, the sensor information is an image of a road on which the vehicle can travel. That is, the surface layer state is the state of the road. On the other hand, in a case where the ground surface observation system 30 uses an SAR mounted on an artificial satellite, the displacement is a displacement that also includes a portion other than the road. As described above, in general, the range of the displacement is wider than the range of the surface layer state.

For example, in the case of tunnel construction under the road, the effect of the tunnel construction may spread to the periphery of the road in addition to the road above the tunnel construction. However, the dashcam is not capable of measuring the sensor information in a range other than the road. On the other hand, the SAR can observe a region around the road. Therefore, for example, the effect determination system 13 can more accurately determine the effect of the tunnel construction on the road, using the displacement around the road in addition to the surface layer state and displacement of the road above the tunnel construction. As a result, the effect determination system 13 can more appropriately determine the effect of the event. As described above, the displacement and the surface layer state have different advantages. Therefore, the effect determination system 13 implements more appropriate determination of the effect of the event, using both the displacement and the surface layer state.

Similarly to the effect determination systems 11 and 12, the effect determination system 13 may use at least one of a speed that is a rate of change in the displacement and acceleration that is a rate of change in the speed of the displacement in addition to or instead of the displacement. The effect determination system 13 may use a speed that is a rate of change in the surface layer state or acceleration that is a rate of change in the speed of the surface layer state in addition to or instead of the surface layer state. For example, in a case where the surface layer state is deterioration, the speed of the surface layer state is a speed at which the deterioration of the surface layer progresses. For example, in a case where a crack is used as the surface layer state, the rate of change in the surface layer state is a rate of increase in the crack rate or a rate at which the area of the crack expands. The speed of the surface layer state and the acceleration of the surface layer state can be calculated based on the accumulated data.

### (3) Display Device 40

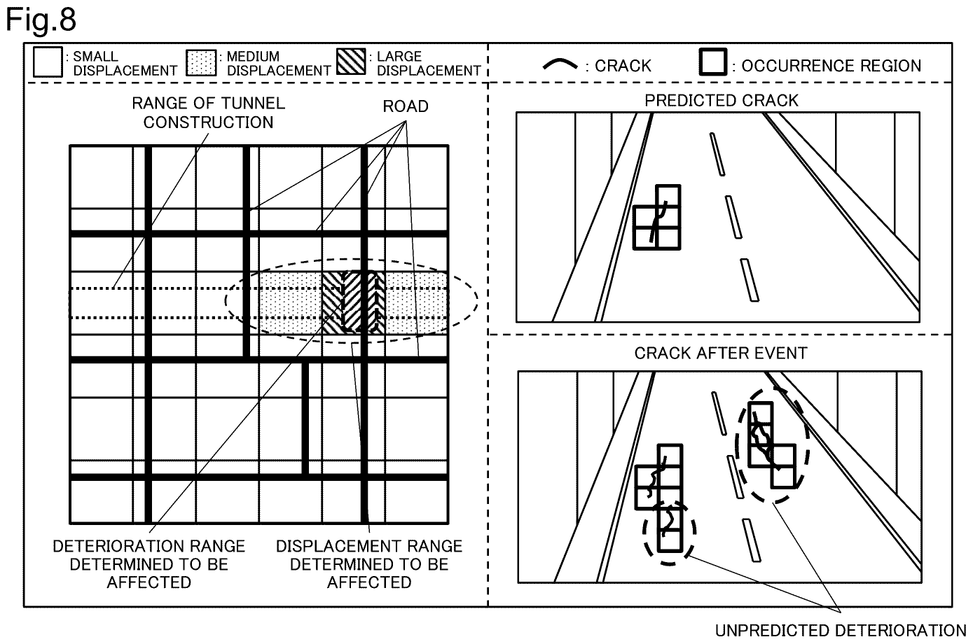

The display device 40 displays the determination result as in the second example embodiment. The display device 40 may display at least one of the sensor information and the surface layer state in addition to the determination result from the effect determination system 13. FIG. 8 is a diagram illustrating an example of display including the sensor information and the surface layer state. In FIG. 8, the display device 40 displays a deterioration range and a displacement range determined to be affected by the event on the left side. The display device 40 displays the image of the road and cracks as an example of the sensor information and the surface layer state on the right side of FIG. 8. An upper portion of the right side is a predicted crack. A lower portion of the right side is cracks after the event. In FIG. 8, the display device 40 displays squares indicating the position of the crack. Referring to the upper and lower views of the right side of FIG. 8, two cracks surrounded by dashed ellipses in the lower portion of the right side of FIG. 8 are unpredicted cracks. That is, the cracks are estimated to occur under the effect of the tunnel construction.

### <Hardware Configuration>

Next, a hardware configuration of the effect determination systems 11, 12, and 13 will be described using the effect determination system 13. Each component of the effect determination system 13 may be configured by hardware circuits. Alternatively, in the effect determination system 13, each component may be configured using a plurality of devices that are connected via a network. For example, the effect determination system 13 may be configured using cloud computing. Alternatively, in the effect determination system 13, a plurality of components may be configured by one hardware component.

The effect determination system 13 may be implemented as a computer device including a central processing unit (CPU), a read only memory (ROM), and a random access memory (RAM). The effect determination system 13 may be implemented as a computer device including another configuration, such as a network interface card (NIC), in addition to the above-described configurations.

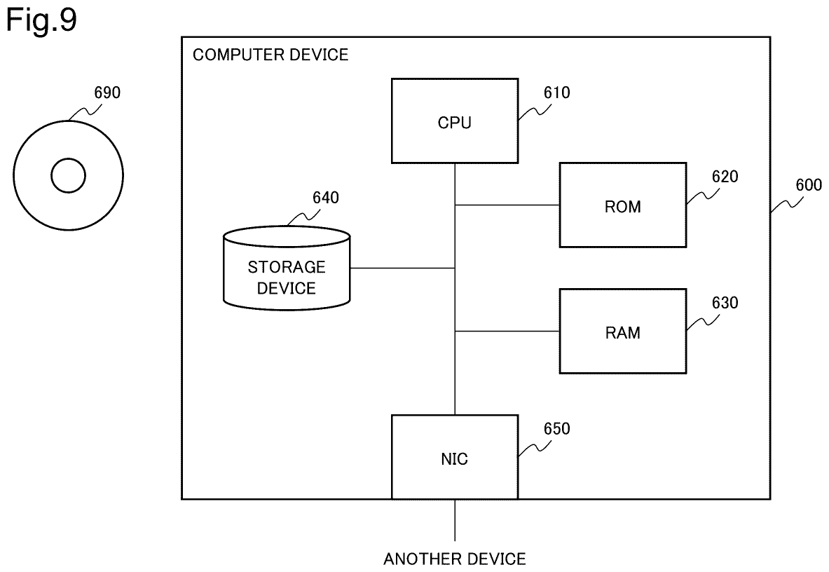

FIG. 9 is a block diagram illustrating an example of a hardware configuration of a computer device 600 constituting the effect determination system 13. The computer device 600 includes a CPU 610, a ROM 620, a RAM 630, a storage device 640, and an NIC 650. The CPU 610 reads a program from at least one of the ROM 620 and the storage device 640. Then, the CPU 610 controls the RAM 630, the storage device 640, and the NIC 650 based on the read program. Then, the computer device 600 including the CPU 610 controls these configurations to implement functions of the predicted displacement acquisition unit 150, the displacement acquisition unit 160, the displacement storage unit 165, and the effect determination unit 183 of the effect determination system 13. The computer device 600 implements functions of the sensor information acquisition unit 120, the predicted state acquisition unit 110, the sensor information storage unit 125, and the state determination unit 130.

When implementing each function, the CPU 610 may use at least one of the RAM 630 and the storage device 640 as a temporary storage medium for programs and data. The CPU 610 may read a program included in a recording medium 690 that stores computer-readable programs, using a recording medium reading device (not illustrated). Alternatively, the CPU 610 may acquire a program from another device (not illustrated) via the NIC 650, store the acquired program in at least one of the RAM 630 and the storage device 640, and operate based on the stored program.

The ROM 620 stores the programs executed by the CPU 610 and fixed data. The ROM 620 is, for example, a programmable ROM (P-ROM) or a flash ROM. The RAM 630 temporarily stores at least one of the program executed by the CPU 610 and data. The RAM 630 is, for example, a dynamic RAM (D-RAM). The storage device 640 stores the data and programs to be stored for a long time by the computer device 600. The storage device 640 implements the functions of the sensor information storage unit 125 and the displacement storage unit 165. The storage device 640 may operate as a temporary storage device of the CPU 610. The storage device 640 is, for example, a hard disk device, a magneto-optical disk device, a solid state drive (SSD), or a disk array device.

The ROM 620 and the storage device 640 are non-transitory recording media. On the other hand, the RAM 630 is a transitory recording medium. The CPU 610 can operate based on the program stored in at least one of the ROM 620, the storage device 640, and the RAM 630. That is, the CPU 610 can operate using at least one of the non-transitory recording medium and the transitory recording medium.

The NIC 650 relays exchange of data with another device (not illustrated) via the network. The NIC 650 is, for example, a local area network (LAN) card. The NIC 650 is not limited to the wired communication card and may be a wireless communication card. In the computer device 600 configured as described above, the CPU 610 implements the same functions as those of the effect determination system 11, 12, or 13 based on the program.

### <Example of Usage of Effect Determination System>

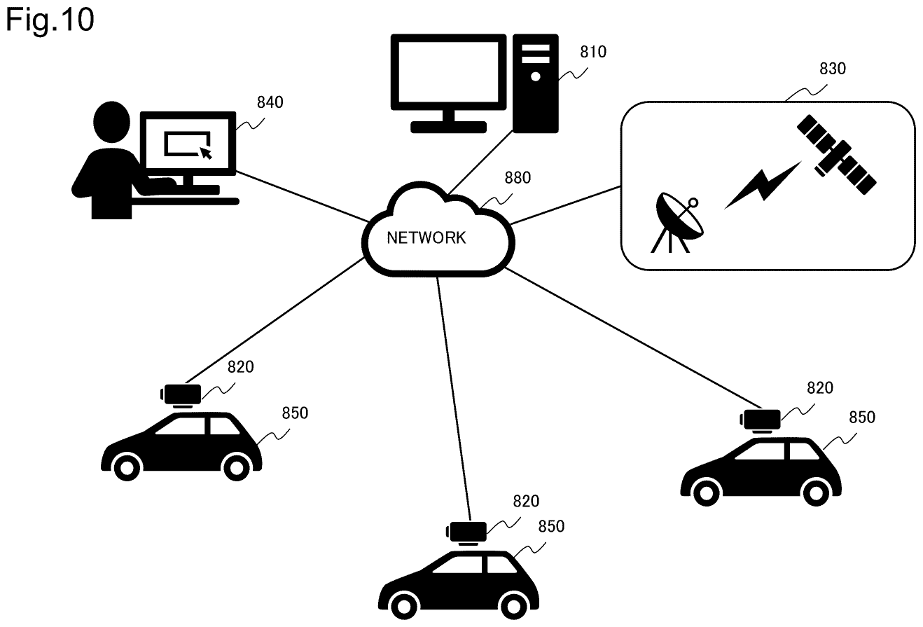

As a description of the effect determination system 13, a specific example of a system using the effect determination system 13 will be described with reference to the drawings. FIG. 10 is a conceptual diagram illustrating the entire system. In FIG. 10, the subjects of the configurations may be the same or different. In FIG. 10, a computer device 810 is an example of the effect determination system 13. A dashcam 820 is an example of the sensor information measurement device 20. An SAR system 830 including an artificial satellite equipped with an SAR and a ground station is an example of the ground surface observation system 30. A terminal device 840 is an example of the display device 40. A vehicle 850 is an example of the moving object. In FIG. 10, the dashcam 820 is mounted outside the vehicle 850. However, the dashcam 820 may be mounted inside the vehicle 850.

A network 880 is a communication path that connects each device and each system. For example, the network 880 may be the Internet, a public telephone line, a dedicated communication network, or a combination thereof. However, the network 880 is not limited to the above and may be any communication path as long as it is a communication path capable of connecting each device and each system. The network 880 may be configured using a plurality of networks instead of one network. For example, the network 880 may be configured using different networks as the networks used for the following connections between the computer device 810 and other devices or systems.
Connection Between Computer Device 810 and Dashcam 820
Connection Between Computer Device 810 and SAR System 830
Connection Between Computer Device 810 and Terminal Device 840

Alternatively, in a case where a plurality of dashcams 820 is included, the network 880 may be configured using a plurality of networks associated to the positions of the dashcams 820 as the connections between the computer device 810 and the dashcams 820.

As described above, the number of configurations included in FIG. 10 is an example and is not limited to the number illustrated in FIG. 10. For example, the number of dashcams 820 is not limited to three and may be one, two, or four or more. The configurations illustrated in FIG. 10 can be replaced with other devices or systems. For example, the dashcam 820 may be mounted on a moving object, such as a drone, different from the vehicle 850. Alternatively, the dashcam 820 may be replaced with a fixed camera.

The vehicle 850 is equipped with the dashcam 820 and travels on a structure such as a road or a bridge. The vehicle 850 may travel in a structure such as a tunnel. The dashcam 820 measures the sensor information of the structure, such as a road or a bridge, on which the vehicle 850 travels and outputs the measured sensor information to the computer device 810. For example, the dashcam 820 measures an image and acceleration as the sensor information and outputs the sensor information to the computer device 810. The SAR system 830 outputs an observation result of a ground surface to the computer device 810. Alternatively, the SAR system 830 analyzes the observation result and outputs the displacement of the ground surface including the structure.

The computer device 810 acquires the pre-event sensor information from the dashcam 820 and stores the pre-event sensor information. Then, the computer device 810 acquires the predicted surface layer state based on the pre-event sensor information. The computer device 810 acquires the post-event sensor information from the dashcam 820. Then, the computer device 810 determines the post-event surface layer state based on the post-event sensor information. The computer device 810 obtains the observation result before the event from the SAR system 830, analyzes the acquired observation result to acquire the pre-event displacement, and stores the pre-event displacement. Alternatively, the computer device 810 acquires the pre-event displacement from the SAR system 830 and stores the pre-event displacement. That is, the computer device 810 stores the pre-event displacement that is the result of the analysis using the observation before the event in the SAR system 830. Then, the computer device acquires the predicted displacement based on the pre-event displacement. The computer device 810 acquires the post-event displacement from the SAR system 830. Then, the computer device 810 determines the effect of the event on the structure based on the predicted surface layer state, the post-event surface layer state, the predicted displacement, and the post-event displacement. Then, the computer device 810 outputs the determination result to the terminal device 840. The terminal device 840 displays the determination result acquired from the computer device 810.

Generally available products and systems can be applied as the computer device 810, the dashcam 820, the SAR system 830, the terminal device 840, and the vehicle 850. For example, a general personal computer may be used as the computer device 810. As described above, the devices and systems used as the computer device 810, the dashcam 820, the SAR system 830, the terminal device 840, and the vehicle 850 are not particularly limited.

Some or all of the above-described example embodiments may be described as the following supplementary notes, but are not limited to the following supplementary notes.

### (Supplementary Note 1)

An effect determination system including:
a predicted displacement acquisition means for acquiring a predicted displacement of a structure after an event, the predicted displacement being a displacement of the structure on a ground surface and having been predicted based on a pre-event displacement acquired before the event related to a ground of the structure;
a displacement acquisition means for acquiring a post-event displacement of the structure based on an observation result of the ground surface observed after the event; and
an effect determination means for determining an effect of the event on the structure based on the predicted displacement and the post-event displacement.

### (Supplementary Note 2)

The effect determination system according to Supplementary Note 1, wherein
the predicted displacement acquisition means acquires the predicted displacement based on the pre-event displacement.

### (Supplementary Note 3)

The effect determination system according to Supplementary Note 1 or 2, wherein
the predicted displacement acquisition means acquires the predicted displacement at each of a plurality of time points after the event,
the displacement acquisition means acquires the post-event displacement at each of the plurality of time points after the event, and
the effect determination means determines the effect of the event based on the predicted displacement and the post-event displacement at each of the plurality of time points after the event.

### (Supplementary Note 4)

The effect determination system according to any one of Supplementary Notes 1 to 3, wherein
the displacement acquisition means acquires the pre-event displacement and the post-event displacement at each of a plurality of positions,
the predicted displacement acquisition means acquires the predicted displacement at each of the plurality of positions based on the pre-event displacement at each of the plurality of positions, and
the effect determination means determines the effect of the event based on the predicted displacement and the post-event displacement at each of the plurality of positions.

### (Supplementary Note 5)

The effect determination system according to any one of Supplementary Notes 1 to 4, wherein
the displacement acquisition means adds the acquired post-event displacement to the pre-event displacement, and
the predicted displacement acquisition means uses the pre-event displacement to which the post-event displacement has been added in acquisition of a next predicted displacement.

### (Supplementary Note 6)

The effect determination system according to any one of Supplementary Notes 1 to 5, further including:
a predicted state acquisition means for acquiring a predicted surface layer state of the structure after the event, the predicted surface layer state being sensor information related to a surface of the structure and having been predicted based on pre-event sensor information measured before the event;
a sensor information acquisition means for acquiring post-event sensor information measured after the event; and
a state determination means for determining a post-event surface layer state of the structure based on the post-event sensor information, wherein
the effect determination means determines the effect of the event on the structure based on the predicted surface layer state and the post-event surface layer state.

### (Supplementary Note 7)

The effect determination system according to Supplementary Note 6, wherein
the predicted state acquisition means acquires the predicted surface layer state based on the pre-event sensor information.

### (Supplementary Note 8)

The effect determination system according to any one of Supplementary Notes 1 to 7, wherein
the event is at least one of an underground construction of the structure, a construction around the structure, a ground construction, an accident, and a disaster.

### (Supplementary Note 9)

The effect determination system according to any one of Supplementary Notes 1 to 8, wherein
the effect determination means acquires the predicted displacement further based on at least one of a geological layer of the ground of the structure, a range in which the event has occurred, a topography around the structure, a geology, soil, weather, a construction type, and a construction method.

### (Supplementary Note 10)

The effect determination system according to any one of Supplementary Notes 1 to 9, wherein
the displacement acquisition means acquires the post-event displacement based on an observation result of a ground surface observation system including a synthetic aperture radar that observes a ground surface including the structure.

### (Supplementary Note 11)

The effect determination system according to Supplementary Note 6 or 7, wherein
the sensor information acquisition means acquires the post-event sensor information from a sensor information measurement device mounted on a moving object.

### (Supplementary Note 12)

The effect determination system according to Supplementary Note 11, wherein
the moving object is a vehicle,
the sensor information measurement device is a dashboard camera, and
the sensor information is an image of the surface of the structure.

### (Supplementary Note 13)

An effect determination method including:
acquiring a predicted displacement of a structure after an event, the predicted displacement being a displacement of the structure on a ground surface and having been predicted based on a pre-event displacement acquired before the event related to a ground of the structure;
acquiring a post-event displacement of the structure based on an observation result of the ground surface observed after the event; and
determining an effect of the event on the structure based on the predicted displacement and the post-event displacement.

### (Supplementary Note 14)

A recording medium having recorded thereon a program causing a computer to execute:
a process of acquiring a predicted displacement of a structure after an event, the predicted displacement being a displacement of the structure on a ground surface and having been predicted based on a pre-event displacement acquired before the event related to a ground of the structure;
a process of acquiring a post-event displacement of the structure based on an observation result of the ground surface observed after the event; and
a process of determining an effect of the event on the structure based on the predicted displacement and the post-event displacement.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

11 effect determination system
12 effect determination system
13 effect determination system
20 sensor information measurement device
30 ground surface observation system
40 display device
110 predicted state acquisition unit
120 sensor information acquisition unit
125 sensor information storage unit
130 state determination unit
150 predicted displacement acquisition unit
160 displacement acquisition unit
165 displacement storage unit
180 effect determination unit
183 effect determination unit
600 computer device
610 CPU
620 ROM
630 RAM
640 storage device
650 NIC
810 computer device
820 dashboard camera
830 SAR system
840 terminal device
850 vehicle
880 network

What is claimed is:

1. An effect determination system comprising:
a memory configured to store instructions; and
one or more processors configured to execute the instructions to:
acquire a predicted displacement of a structure after an event, the predicted displacement being a displacement of the structure on a ground surface and having been predicted based on a pre-event displacement acquired before the event related to a ground of the structure;
acquire a post-event displacement of the structure based on an observation result of the ground surface observed after the event; and
determine an effect of the event on the structure based on the predicted displacement and the post-event displacement.

2. The effect determination system according to claim 1, wherein
the one or more processors are further configured to execute the instructions to:
acquire the predicted displacement based on the pre-event displacement.

3. The effect determination system according to claim 1, wherein
the one or more processors are further configured to execute the instructions to:
acquire the predicted displacement at each of a plurality of time points after the event;
acquire the post-event displacement at each of the plurality of time points after the event; and
determine the effect of the event based on the predicted displacement and the post-event displacement at each of the plurality of time points after the event.

4. The effect determination system according to claim 1 wherein
the one or more processors are further configured to execute the instructions to:
acquire the pre-event displacement and the post-event displacement at each of a plurality of positions;
acquire the predicted displacement at each of the plurality of positions based on the pre-event displacement at each of the plurality of positions; and
determine the effect of the event based on the predicted displacement and the post-event displacement at each of the plurality of positions.

5. The effect determination system according to claim 1, wherein
the one or more processors are further configured to execute the instructions to:
add the acquired post-event displacement to the pre-event displacement to be stored; and
use the pre-event displacement to which the post-event displacement has been added in acquisition of a next predicted displacement.

6. The effect determination system according to claim 1, wherein
the one or more processors are further configured to execute the instructions to:
acquire a predicted surface layer state of the structure after the event, the predicted surface layer state being sensor information related to a surface of the structure and having been predicted based on pre-event sensor information measured before the event;
acquire post-event sensor information measured after the event;
determine a post-event surface layer state of the structure based on the post-event sensor information; and
determine the effect of the event on the structure based on the predicted surface layer state and the post-event surface layer state.

7. The effect determination system according to claim 6, wherein
the one or more processors are further configured to execute the instructions to:
acquire the predicted surface layer state based on the pre-event sensor information.

8. The effect determination system according to claim 1, wherein
the event is at least one of an underground construction of the structure, a construction around the structure, a ground construction, an accident, and a disaster.

9. The effect determination system according to claim 1, wherein
the one or more processors are further configured to execute the instructions to:
acquire the predicted displacement further based on at least one of a geological layer of the ground of the structure, a range in which the event has occurred, a topography around the structure, a geology, soil, weather, a construction type, and a construction method.

10. The effect determination system according to claim 1, wherein
the one or more processors are further configured to execute the instructions to:
acquire the post-event displacement based on an observation result of a ground surface observation system including a synthetic aperture radar that observes a ground surface including the structure.

11. The effect determination system according to claim 6, wherein
the one or more processors are further configured to execute the instructions to:
acquire the post-event sensor information from a sensor information measurement device mounted on a moving object.

12. The effect determination system according to claim 11, wherein
the moving object is a vehicle,
the sensor information measurement device is a dashboard camera, and
the sensor information is an image of the surface of the structure.

13. An effect determination method comprising:
acquiring a predicted displacement of a structure after an event, the predicted displacement being a displacement of the structure on a ground surface and having been predicted based on a pre-event displacement acquired before the event related to a ground of the structure;
acquiring a post-event displacement of the structure based on an observation result of the ground surface observed after the event; and
determining an effect of the event on the structure based on the predicted displacement and the post-event displacement.

14. A non-transitory computer-readable recording medium having recorded thereon a program causing a computer to execute:
acquiring a predicted displacement of a structure after an event, the predicted displacement being a displacement of the structure on a ground surface and having been predicted based on a pre-event displacement acquired before the event related to a ground of the structure;
acquiring a post-event displacement of the structure based on an observation result of the ground surface observed after the event; and
determining an effect of the event on the structure based on the predicted displacement and the post-event displacement.
